(19) United States
(12) Patent Application Publication
(10) Pub. No.: US 2018/0245558 A1
(43) Pub. Date: Aug. 30, 2018

(54) SHAFT SEAL

(71) Applicant: Aktiebolaget SKF, Goteborg (SE)

(72) Inventor: Christoph Eck, Bergisch-Gladbach (DE)

(21) Appl. No.: 15/902,517

(22) Filed: Feb. 22, 2018

(30) Foreign Application Priority Data
Feb. 24, 2017 (DE) 102017203083.6

(51) Int. Cl. F02M 55/00; F16J 15/00; F16J 15/3208

(52) U.S. Cl. CPC F02M 55/004; F16J 15/002; F16J 15/3284; F02M 2200/16; F16J 15/3208

(57) ABSTRACT

A shaft seal configured to seal an oil space from a fuel space of an injection pump for an internal combustion engine coaxially and sealingly surrounds a rod configured to oscillate axially with respect to the shaft seal. The shaft seal is configured to seat in a bore of a housing of the injection pump in a sealing manner, and the shaft seal includes a first seal element to which a second seal element is axially connected. The first seal element and the second seal element are configured as substantially hollow cylinders and may be formed from different materials.

### CROSS-REFERENCE

This application claims priority to German patent application no. 10 2017 203 083.6 filed on Feb. 24, 2017, the contents of which are fully incorporated herein by reference.

### TECHNOLOGICAL FIELD

The disclosure relates to a shaft seal for sealing an oil space with respect to a fuel space of an injection pump for an internal combustion engine. The shaft seal coaxially and sealingly encloses an axially oscillating rod and is received in a sealing-seated manner in a bore of a housing of the injection pump.

### BACKGROUND

For increased fuel efficiency, modern internal combustion engines are usually equipped with injection pumps for introducing fuel into combustion chambers. In an injection pump, at least one shaft seal is necessary for sealing an oil space of a cam or crank drive, which serves to drive a high-pressure pump for the fuel injection into the combustion chamber, with respect to a fuel space.

Shaft seals made of PTFE, which are cut from solid stock and which have double-side acting and radially inwardly elastically preloaded seal lips, are widely used as shaft seals.

A disadvantage of these previously known embodiments of shaft seals can be seen in their relatively high manufacturing and material expense.

### SUMMARY

An aspect of the disclosure is therefore to provide a shaft seal that in terms of manufacturing technology can be more easily manufactured and installed.

Since the shaft seal is formed using a first seal element, on which a second seal element axially abuts, and the two seal elements are each formed essentially hollow-cylindrical, a more cost-effective manufacturing process inter alia and a simplified installing are possible. Here the two-part seal assembly can withstand a continuous pressure of up to 5 bar with short-term pressure peaks of up to 30 bar. Furthermore, due to the two-part embodiment, the sealing properties of the shaft seal with respect to the fuel space and the oil space can be individually adapted.

According to one advantageous further development of the shaft seal, the second seal element includes an approximately hollow-cylindrical base body including a seal lip for sealing the oil space, which seal lip encircles and is preloaded radially inward against the rod by a clamping element. A reliable sealing effect is thereby provided with respect to the cylindrical rod that moves back and forth in an oscillating manner up to 200 times per second and thereby by up to 10 mm axially within the seal assembly.

In a further embodiment the clamping element, in particular an annular coil spring, is received in a radially outer-lying annular groove of the base body of the second seal element. A robust constructive structure is thereby provided.

According to a further development, the first seal element is formed using a thermoplastic plastic, in particular using PTFE, and the second seal element using an elastomer, in particular using rubber or hard rubber. As a result different materials or plastics can be used for the two seal elements, which contributes to cost optimization.

The first seal element for sealing the fuel space preferably includes an approximately hollow-cylindrical base body including a seal edge abutting on all sides on the rod, which seal edge is preloaded radially inward against the rod by a spring element, in particular an O-ring. As a result of the preferably sharp-edged seal edge preloaded radially inward by the spring element, a particularly reliable sealing of the fuel space under pressure is achievable. An axial spacing between the seal edge and the seal lip is preferably dimensioned larger than a maximum axial travel path or stroke of the rod in the seal assembly, in order to minimize a mixing of oil from the oil space and fuel from the fuel space.

The spring element of the first seal element is preferably disposed between a larger-diameter first bore section and a concave outer surface of the seal edge. Consequently a radially inwardly directed mechanical preload of the seal edge, preferably having a sharp-edge or having a small radius of curvature, is realizable. Furthermore due to the radially outward facing concave recess of the seal surface a reliable seat of the spring element or of the O-ring is ensured.

In a further development the first seal element includes a radially outwardly directed flange that abuts at least sectionally on the larger-diameter first bore section. A reliable seat is thereby provided of the first seal element in the bore.

In the case of a preferred embodiment, a sleeve section facing the second seal element connects to the flange of the first seal element, wherein a radially outwardly lying annular space remains between the larger-diameter first bore section and the sleeve section. Due to the annular space an interference-fit coupling between the two seal elements or a mutual interlocking thereof is realizable.

An encircling shoulder for the axial position-securing of the second seal element is preferably formed between the larger-diameter first bore section and a smaller-diameter second bore section. Consequently a one-side axial position-securing of the seal assembly in the bore is ensured.

In one technically favorable design the second seal element includes a sleeve-shaped extension facing the first seal element, which sleeve-shaped extension is at least sectionally receivable with interference-fit by the annular space, wherein the sleeve-shaped extension merges into the approximately hollow-cylindrical base body of the second seal element. Consequently a reliable axial connection of the two seal elements is ensured.

A reinforcing element is preferably integrated into the second seal element, which reinforcing element includes a tubular section and a radially inwardly directed flange section connecting thereto. Due to the presence of the reinforcing element, preferably formed using a metallic material the mechanical loadability of the axial connection between the two seal elements is optimized. The reinforcing element can, for example, be in-vulcanized, for example, with the rubber or the hard rubber of the second seal element. The reinforcing element includes an essentially pot-shaped geometry including a hollow-cylindrical wall and a base, wherein a circular recess is introduced centrally in the base.

### BRIEF DESCRIPTION OF THE DRAWINGS

FIG. 1 is a longitudinal sectional view through an seal assembly according to the present disclosure.

### DETAILED DESCRIPTION

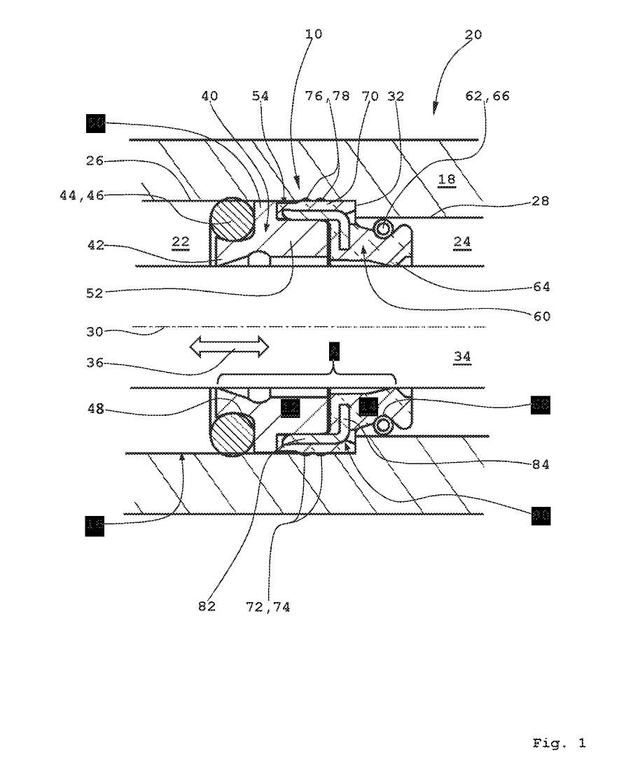

FIG. 1 illustrates a perspective view of an underside. A shaft seal 10 comprises a first seal element 12, on which a second seal element 14 axially abuts. The two seal elements 12, 14 each approximately have a hollow-cylindrical geometry. The shaft seal 10 is inserted on a continuous bore 16 of a housing 18 of an injection pump 20 and separates a fuel space 22 and an oil space 24 from each other to the greatest extent possible in a hermetically tightly sealing manner. The fuel space 22 is filled with a fuel, such as, for example, gasoline or diesel, while oil is located in the oil space 24, which oil serves for lubricating a cam- or crank-drive, which is necessary for the driving of a not-depicted high-pressure pump for fuel injection into the combustion chambers of an also not-depicted internal combustion engine. The bore 16 has a larger-diameter first bore section 26 and a smaller-diameter second bore section 28 connecting axially thereto, between which a shoulder 32 extending perpendicular to a longitudinal central axis 30 of the bore 16 and of the shaft seal 10 extends. The shaft seal 10 coaxially encloses a cylindrical rod 34, which serves for driving the high-pressure pump and which moves back and forth in an oscillating manner up to 200 times per second (200 Hz) along an axial travel path 36 or a stroke path of up to 10 mm parallel to the longitudinal axis 30.

The first seal element 12 is formed using a thermoplastic plastic, preferably using PTFE (polytetrafluoroethylene), while the second seal element 14 is constructed using a sufficiently plastic- and oil-resistant elastomer, such as, for example, rubber or hard rubber.

For effectively sealing the fuel space 22, the first seal element includes an approximately hollow-cylindrical base body 40 including a seal edge 42 abutting circumferentially on the rod 34, which seal edge 42 is mechanically preloaded radially inward against the rod 34 by, for example, a spring element 44, in particular an O-ring 46. The O-ring 46 is supported here between the larger-diameter first bore section 26 and a concavely curved, encircling outer surface 48 of the seal edge 42 and is thereby reliably secured in its axial position. Instead of the O-ring 46 a not-depicted, radially outwardly directed rubber bead can be formed as an integral component of the seal edge 42. Alternatively the seal edge 42 can be configured as a not-depicted “U-cup” seal, in whose U-shaped annular groove a star-shaped groove spring is then inserted for radially inwardly directed mechanical preload of the seal edge 42.

Furthermore the base body 40 of the first seal element 12 includes a radially outwardly directed, disc-shaped flange 50, which abuts the inner side of the larger-diameter first bore section 26, preferably full-surface and in a tightly sealing manner. The seal edge 42 of the seal element 12 is preferably sharp-edged, i.e., it has a smallest possible radius of curvature in order to, among other things, increase the sealing effect with simultaneously minimized friction. A tubular sleeve section 52 facing the second seal element 14 or abutting thereon connects to the flange 50 of the first seal element 12, wherein there is a radially outer lying annular space 54 between the larger-diameter first bore section 26 and the sleeve section 52.

The second seal element 14 also comprises an approximately hollow-cylindrical base body 60 including a seal lip 64, encircling and preloaded radially inward against the rod 34 by a clamping element 62, which seal lip 64 has a larger radius in comparison to the seal edge 42 of the first seal element 12. Here the clamping element 62 is only exemplarily formed as annular coil spring 66, which is received in a radially outer-lying, approximately concave and encircling annular groove 68 or a hollow throat of the base body 60 of the second seal element 14.

Furthermore, a sleeve-shaped extension 70 is integrally shaped on the second seal element 14, which sleeve-shaped extension 70 extends parallel to the longitudinal central axis and which, inter alia, axially borders on the flange 50 of the first seal element 12 or abuts thereon. To establish an axial connection between the two seal elements 12, 14, the sleeve-shaped extension 70 is at least sectionally introducible into the annular space 54 in an interference-fit manner. The sleeve-shaped extension 70 of the second seal element 60 here exemplarily includes two radially outwardly directed, encircling bead-type projections 72, 74 that for axial position-securing are latchable or bringable into engagement with two correspondingly designed recesses 76, 78 in the larger-diameter first bore section 26. An at least sectionally encircling one-piece reinforcing element 80 is preferably integrated into the seal element 14. The reinforcing element 80, which is at least partially embedded into the second seal element 14, includes a tubular section 82 extending parallel to the longitudinal central axis 30, to which section 82 a radially inwardly directed, essentially circular flange section 84 connects, which together have an approximately L-shaped cross-sectional geometry. An axial distance A between the sharp-edged seal edge 42 and the bead-type seal lip 64 is preferably dimensioned such that the distance A is greater than the maximum axial travel path 36 or the stroke path of the rod 34.

Due to the inventive two-part configuration of the shaft seal 10 it can be manufactured more cost-effectively in comparison to the solutions known from the prior art. Furthermore, there is always a thin lubricating film in the region of the fuel space 22, whereas a thicker oil film forms in the region of the oil space 24, with the result that small amounts of oil and fuel can mix and the pressurized seal edge 42 made of PTFE is optimally protected from wear and deformation. Furthermore, the shaft seal 10 can be more easily installed since the seal lip 64 made of rubber or hard rubber is relatively insensitive. In addition, the inventive shaft seal 10 allows a particularly low-friction sealing of the fuel- and oil-space 22 with respect to the rod 34 oscillating back and forth with high frequency.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved shaft seals.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

10 Shaft seal
12 First seal element
14 Second seal element
16 Bore
18 Housing (injection pump)
20 Injection pump
22 Fuel space
24 Oil space
26 First bore section
28 Second bore section
30 Longitudinal central axis (bore)
32 Shoulder (bore)
34 Rod
36 Rod travel path (stroke path)
40 Base body (first D-element)
42 Seal edge
44 Spring element
46 O-ring
48 Concave outer surface
50 Flange
52 Sleeve section
54 Annular space
60 Base body (second D-element)
62 Clamping element
64 Seal lip
66 Annular coil spring
68 Annular groove
70 Extension
72 Projection (extension)
74 Projection (extension)
76 Recess (first bore)
78 Recess (second bore)
80 Reinforcing element
82 Tubular section
84 Flange section
A Axial distance

What is claimed is:

1. A shaft seal configured to seal an oil space from a fuel space of an injection pump for an internal combustion engine, the shaft seal coaxially and sealingly surrounding a rod configured to oscillate axially with respect to the shaft seal, the shaft seal being configured to be seated in a bore of a housing of the injection pump in a sealing manner, the shaft seal including a first seal element to which a second seal element is axially connected, and the first seal element and the second seal element being configured as substantially hollow cylinders.

2. The shaft seal according to claim 1,
wherein the second seal element includes a hollow-cylindrical base body having a seal lip, the seal lip encircling the rod and being preloaded radially inward against the rod by a clamping element, for sealing the oil space.

3. The shaft seal according to claim 2, wherein the clamping element comprises an annular coil spring received in a radially outwardly facing annular groove of the base body of the second seal element.

4. The shaft seal according to claim 1, wherein the first seal element is formed from PTFE and the second seal element is formed from rubber or hard rubber.

5. The shaft seal according to claim 1, wherein the first seal element includes a hollow-cylindrical base body including a seal edge abutting on the rod on all sides, the seal edge being preloaded radially inward against the rod by an O-ring.

6. The shaft seal according to claim 5, wherein the bore has a large-diameter portion and a smaller diameter portion that meets the large-diameter portion at a shoulder and wherein the O-ring is disposed between the large-diameter portion of the bore and a concave outer surface of the seal edge.

7. The shaft seal according to claim 6, wherein the first seal element includes a radially outwardly directed flange abutting at least sectionally on the large-diameter portion of the bore.

8. The shaft seal according to claim 7, wherein a sleeve section projects from the flange of the first seal element toward the second seal element such that a radially outer-lying annular space is formed between the large-diameter portion of the bore and the sleeve section.

9. The shaft seal according to claim 8, wherein the second seal element includes a sleeve-shaped extension facing the first seal element, which sleeve-shaped extension is at least sectionally receivable in the annular space in an interference-fit manner, and wherein the sleeve-shaped extension projects into the hollow-cylindrical base body of the second seal element.

10. The shaft seal according to claim 1,
wherein the first seal element is formed of PTFE and is configured to face a fuel side of the injection pump and wherein the second seal element is formed of rubber and is configured to face an oil side of the injection pump,
wherein the first seal element includes a body, a seal lip projecting radially inwardly from the body and configured to contact the rod and a radially outwardly extending flange configured to contact the bore, and
wherein the second seal element includes a body, a seal lip projecting radially inwardly from the second seal element body and a cylindrical sleeve extending from the second seal element body into a radial gap between the first seal element body and the bore.

11. An assembly comprising:
the housing having the bore;
the rod; and
the shaft seal according to claim 1 mounted between the housing and the rod such that the cylindrical sleeve contacts the bore.

12. An injection pump of an internal combustion engine comprising the assembly according to claim 11.

13. A shaft seal configured to seal an oil space from a fuel space of an injection pump for an internal combustion engine by sealing an axially reciprocating rod relative to a housing bore of the injection pump, the shaft seal comprising:
a first seal element comprising a hollow cylinder; and
a second seal element comprising a hollow cylinder axially connected to the first seal element;
wherein the first seal element is formed of PTFE and is configured to face a fuel side of the injection pump and wherein the second seal element is formed of rubber and is configured to face an oil side of the injection pump,
wherein the first seal element includes a body, a seal lip projecting radially inwardly from the body and configured to contact the rod and a radially outwardly extending flange configured to contact the bore, and
wherein the second seal element includes a body, a seal lip projecting radially inwardly from the second seal element body and a cylindrical sleeve extending from the second seal element body into a radial gap between the first seal element body and the bore.

14. An assembly comprising:
the housing having the bore;
the rod; and
the shaft seal according to claim 13 mounted between the housing and the rod such that the cylindrical sleeve contacts the bore.

15. An injection pump of an internal combustion engine comprising the assembly according to claim 14.
